(19) United States
(12) Patent Application Publication
(10) Pub. No.: US 2006/0080826 A1
(43) Pub. Date: Apr. 20, 2006

(54) Sliding-surface mounting and method of producing the mounting

(75) Inventors: Karl-Heinz Helmstadter, Heidelberg (DE); Olaf Lorenz, Ludwigshafen (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/251,484

(22) Filed: Oct. 14, 2005

(30) Foreign Application Priority Data
Oct. 14, 2004 (DE) 10 2004 050 011.8

(51) Int. Cl. B23P 17/04

(52) U.S. Cl. 29/592

(57) ABSTRACT

In a method for producing a pivotable bearing between a gripper and a gripper tube bearing the latter or between a gripper shaft and a gripper tube enclosing the latter coaxially, provision is made for all the components to be mounted on the gripper tube to be fixed before a sliding bearing formed as a resin-hardener system is introduced between the respectively pivotably connected parts. In this manner, deformations brought about by the fixing of the components can be compensated for.

### BACKGROUND OF THE INVENTION

### Field of the Invention

The invention relates to a mounting for a gripper system for the transport of sheets in a sheet processing machine, and contains a gripper shaft which is mounted in a gripper tube. The invention further pertains to a method for producing the mounting.

It is known, for example from German patent DE 43 17 429 C2 (corresponding to U.S. Pat. No. 5,588,773), to mount a gripper shaft such that it can be pivoted in a gripper tube enclosing the latter coaxially. For this purpose, use is made of bronze bushes that are bonded into the gripper tube.

In particular in the case of tongs grippers, there is the problem that both the gripper shaft and the gripper tube bear gripper elements that in each case have to be fixed to the gripper shaft and tube. Fixing the gripper elements to the gripper tube necessarily causes deformations of the gripper tube, which can impair the function of the mountings and thus lead to greater wear and bearing play caused thereby, as well as a shorter lifetime of the mountings.

### SUMMARY OF THE INVENTION

It is accordingly an object of the invention to provide a sliding-surface mounting and a method of producing the mounting which overcomes the above-mentioned disadvantages of the prior art devices and methods of this general type.

With the foregoing and other objects in view there is provided, in accordance with the invention, a method for producing a pivotable mounting of a gripper shaft in a gripper tube in a sheet-processing machine. The method includes coating the gripper shaft with a release agent in a region of the pivotable mounting, fixing necessary components on the gripper tube, mounting the gripper shaft in the gripper tube, and introducing a liquid resin-hardener system between the gripper shaft and the gripper tube in a region of an envisaged bearing point.

A particular advantage of the invention is that a virtually play-free, low-wear mounting for a shaft/tube system as a functional element for a sheet holding system is provided, it being possible for components to be fixed to the tube with sufficiently high forces at the same time without exerting any disadvantageous effect on the shaft/tube mounting.

Advantageously, as a result of applying a coating of a release agent to the shaft, following the solidification of a liquid resin introduced between shaft and tube, the shaft remains rotatable, while the resin enters into a firm adhesive and/or form-fitting connection with the tube, which is roughened on its inside.

It has proven to be particularly advantageous if the components to be fixed are disposed on the tube before being filled with the liquid resin. Any pipe deformations that may arise in this case can then be compensated for by the resin.

As a result of supplying heat during the solidification of the sliding layer material (resin-hardener systems) or heating the shaft before the filling, a defined minimum play can be produced between the shaft and the tube by utilizing material shrinkage properties.

Other features which are considered as characteristic for the invention are set forth in the appended claims.

Although the invention is illustrated and described herein as embodied in a sliding-surface mounting and a method of producing the mounting, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a sheet-processing press;

FIG. 2 is a diagrammatic, perspective view of a tongs gripper system for transporting sheets according to the invention; and

FIG. 3 is a diagrammatic, sectional view of a conventional sheet gripper.

### DESCRIPTION OF THE PREFERRED EMBODIMENTS

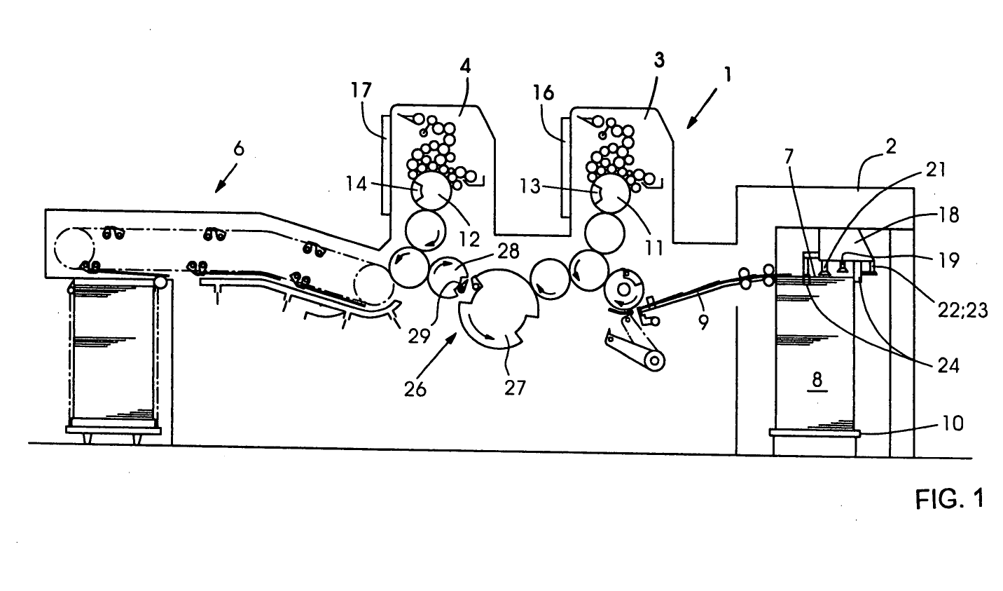

Referring now to the figures of the drawing in detail and first, particularly, to FIG. 1 thereof, there is shown a machine for processing sheets 7, for example a press 1. The press has a feeder 2, at least one printing unit 3, 4 and a deliverer 6. The sheets 7 are removed from a sheet stack 8 and are supplied, separated or overlapping, over a feed table 9 to the printing units 3 and 4. The printing units 3, 4 each contain, in a known way, a plate cylinder 11, 12. The plate cylinders 11 and 12 each have an apparatus 13, 14 for fixing flexible printing plates. Furthermore, each plate cylinder 11, 12 is assigned an apparatus 16, 17 for semiautomatic or fully automatic printing plate change.

The sheet stack 8 rests on a stack board 10 which can be raised under control. The removal of the sheets 7 is carried out from the upper side of the sheet stack 8 by what is known as a suction head 18 which, inter alia, has a number of lifting and dragging suckers 19, 21 for separating the sheets 7. Furthermore, blowing devices 22 for loosening the upper sheet layers and sensing elements 23 for tracking the stack are provided. In order to align the sheet stack 8, in particular the upper sheets 7 of the sheet stack 8, a number of lateral and rear stops 24 are provided.

A number of sheet transporting cylinders is equipped with gripper systems and transport the sheets through the printing units 3, 4 as far as the deliverer 6. A turner device 26, for example, can be provided between two printing units 3, 4. In the exemplary embodiment, this contains a storage drum 27 with a turner drum 28 disposed downstream. The latter has what is known as a tongs gripper system 29.

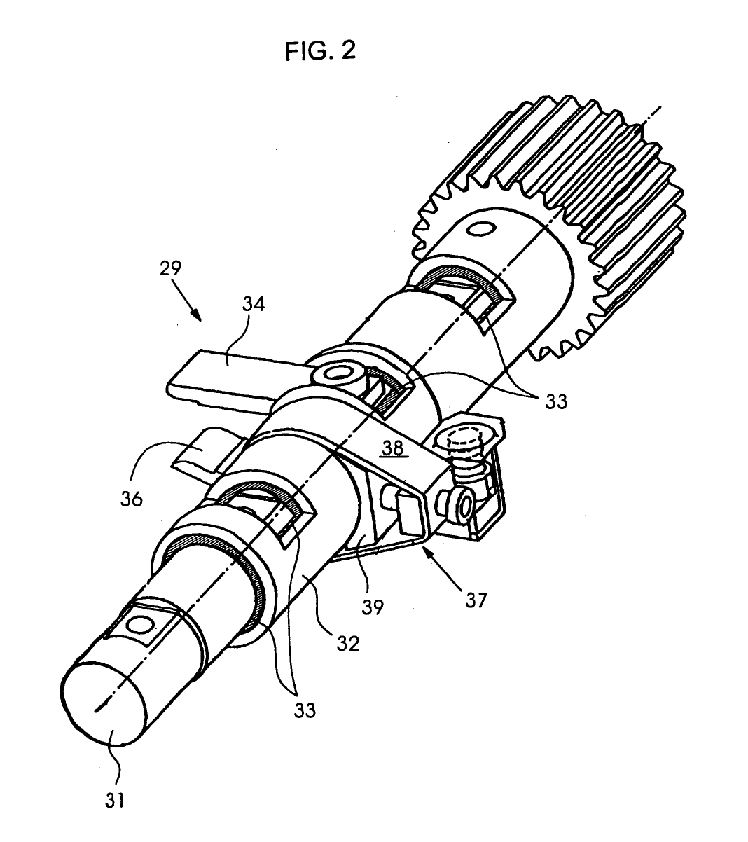

The tongs gripper system 29 substantially contains a gripper shaft 31 and a gripper tube 32 enclosing the latter coaxially (FIG. 2). The gripper tube 32 is mounted such that it can pivot in bearing points on the turner drum 28. The gripper shaft 31 is in turn mounted such that it can pivot in the gripper tube 32. The bearing points contain a sliding layer 33 derived from a resin-hardener system, which is disposed between the gripper shaft 31 and the gripper tube 32. The gripper shaft 31 has a number of first grippers 34 which are disposed at a distance from one another and are in gripping contact with a corresponding number of second grippers 36, which are disposed on the gripper tube 32. For the purpose of fixing and sprung support of the second gripper 36, for example a clamp 37 having a steel band 38 enclosing the gripper tube 32 and a pressure piece 39 are provided. This configuration is substantially also known from German patent DE 43 17 429 A1 (corresponding to U.S. Pat. No. 5,588,773).

The sliding layer 33 for forming a pivotable bearing point between the gripper tube 32 and the gripper shaft 31 is formed as a resin-hardener system 33, which is introduced between the tube 32 and the shaft 31 in a liquid state and then cures. In order to be able to compensate for distortions of the tube 32, first, components such as the second grippers 36, stops, etc., are fixed to the gripper tube 32. The shaft 31 coated with a release agent is then disposed in the gripper tube 32 and the liquid resin-hardener system 33 is then introduced between tube 32 and shaft 31. For this purpose, the tube 32 has a roughened surface, which ensures good retention of the resin-hardener system 33, while the release agent on the shaft 31 ensures its ability to pivot with respect to the tube 32 and the cured resin-hardener system (sliding layer 33).

During the curing phrase of the resin-hardener system 33, by a specific supply of heat during the solidification of the sliding layer material 33 or heating the shaft 31 before the introduction of the sliding layer material 33, a defined minimum play can be produced by utilizing material shrinkage properties.

Of course, the invention can be used not only in tongs gripper systems but also in conventional gripper systems which need a sliding bearing to produce pivoting movements or between the gripper shaft and the stationary shaft or between a housing and the gripper shaft, in particular in sheet-processing machines, preferably presses.

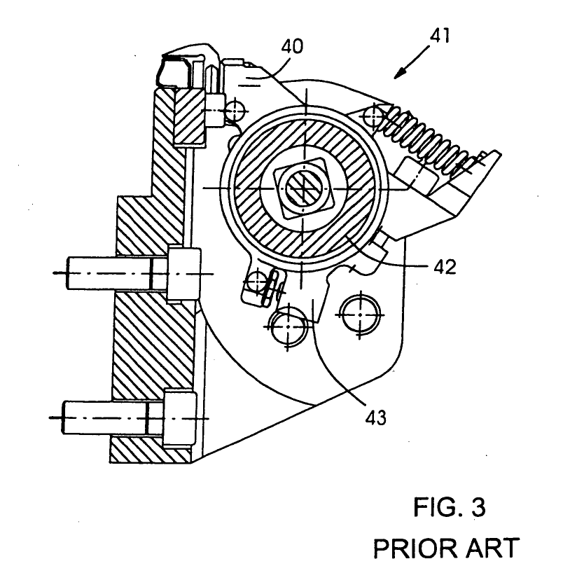

FIG. 3 shows such a conventional gripper 40, which is pivotably mounted on a gripper tube 42 and interacts with a stop 43 that is fixed firmly to the gripper tube 42. In order to produce the pivotable mounting, first the gripper 40 or the gripper housing 41 is coated with a release agent in the region of the envisaged bearing point and other components that are needed, such as the stop 43 seated firmly on the gripper tube 42, are fixed on the gripper tube 42. The resin-hardener system 33 is then introduced in the region of the envisaged bearing point between the gripper 40 or gripper housing 41 and the gripper tube 42.

This application claims the priority, under 35 U.S.C. § 119, of German patent application No. 10 2004 050 011.8, filed Oct. 14, 2004; the entire disclosure of the prior application is herewith incorporated by reference.

We claim:

1. A method for producing a pivotable mounting of a gripper shaft in a gripper tube in a sheet-processing machine, which comprises the steps of:
coating the gripper shaft with a release agent in a region of the pivotable mounting;
fixing necessary components on the gripper tube;
mounting the gripper shaft in the gripper tube; and
introducing a liquid resin-hardener system between the gripper shaft and the gripper tube in a region of an envisaged bearing point.

2. The method according to claim 1, which further comprises supplying heat to the liquid resin-hardener system during a curing phase.

3. The method according to claim 1, which further comprises heating the gripper shaft before introducing the resin-hardener system.

4. The method according to claim 1, wherein the sheet-processing machine is a press.

5. A method for producing a pivotable mounting of a component, selected from the group consisting of a gripper and a gripper housing, on a gripper tube in a sheet-processing machine, which comprises the steps of:
coating the component with a release agent in a region of the pivotable mounting;
disposing the component on the gripper tube;
fixing at least one gripper stop on the gripper tube; and
introducing a liquid resin-hardener system between the gripper tube and the component in a region of an envisaged bearing point.

6. The method according to claim 5, which further comprises supplying heat to the liquid resin-hardener system during a curing phase.

7. The method according to claim 5, wherein the sheet-processing machine is a press.

8. An apparatus for transporting sheets by interacting grippers, the apparatus comprising:
a common gripper shaft;
a gripper tube enclosing said gripper shaft coaxially;
first grippers disposed on said common gripper shaft; and
second grippers in each case interacting with said first grippers and disposed on said gripper tube; and
a cured sliding layer pivotably mounting said gripper shaft on said gripper tube.

9. The apparatus according to claim 8, wherein said gripper tube has a roughened surface in a region of said cured sliding layer.

10. The apparatus according to claim 8, wherein said cured sliding layer is formed of a cured resin-hardener system.

11. An apparatus for transporting sheets, comprising:
a gripper tube;
a stop disposed firmly on said gripper tube;
a cured sliding layer; and
at least one gripper pivotably disposed on said gripper tube and interacting with said stop, said gripper being pivotably mounted on said gripper tube by said cured sliding layer.

12. The apparatus according to claim 11, wherein said gripper tube has a roughened surface in a region of said cured sliding layer.

13. The apparatus according to claim 11, wherein said cured sliding layer is formed of a cured resin-hardener system.
